(19) United States
(12) Patent Application Publication
(10) Pub. No.: US 2009/0291660 A1
(43) Pub. Date: Nov. 26, 2009

(54) MULTI-BAND RECEIVER WITH HARMONIC CANCELLATION AND METHODS FOR USE THEREWITH

(75) Inventor: Jason A. Trachewsky, Menlo Park, CA (US)

Correspondence Address: GARLICK HARRISON & MARKISON, P.O. BOX 160727, AUSTIN, TX, 78716-0727, US

(73) Assignee: Broadcom Corporation, Irvine, CA (US)

(21) Appl. No.: 12/207,646

(22) Filed: Sep. 10, 2008

Related U.S. Application Data
(60) Provisional application No. 61/055,298, filed on May 22, 2008.

(51) Int. Cl. H04B 1/10

(52) U.S. Cl. 455/296

(57) ABSTRACT

A multi-band receiver includes a first receiver coupled to receive a first desired signal component of an RF signal over a first range of frequencies and generate a first received signal. A second receiver receives a second desired signal component of the RF signal over a second range of frequencies and generates a second received signal. The second receiver includes a harmonic cancellation module that attenuates a harmonic of the first desired signal component that falls within the second range of frequencies.

### CROSS-REFERENCE TO RELATED APPLICATIONS

The present application claims priority under 35 U.S.C. 119 from provisionally filed application entitled, “MULTI-BAND RECEIVER WITH HARMONIC CANCELLATION AND METHODS FOR USE THEREWITH, having Ser. No. 61/055,298 and filed on May 22, 2008.

### BACKGROUND OF THE INVENTION

1. Technical Field of the Invention

This invention relates generally to cable/satellite television systems and more particularly to multi-band transceivers used within such systems.

2. Description of Related Art

Cable and satellite networks can provide subscribers with a variety of programming and other services such as analog and/or digital television (TV) signals, broadband data services such as broadband Internet access, analog or digital audio programming, pay-per-view, video on demand and near video on demand programming, premium television channels, interactive advertising and interactive program channels, shopping services and other programming and services. A subscriber can access these programming and services via a receiver that can be incorporated in a set-top box, digital video recorder, cable card, television or other device. In many cases, the receiver includes a multi-band receiver for receiving analog over-the-air or cable TV signals, digital over-the-air signals, digital cable or broadcast satellite signals, digital broadband data signals, multimedia over co-axial (MOCA) signals or other signaling.

Each receiver can include a low noise amplifier, one or more intermediate frequency stages, a filtering stage, and an optional data recovery stage, if digital signals are employed. For a receiver to reliably recover signals/data from inbound RF signals it must be able to isolate desired signal components of the inbound RF signals from interferers (e.g., interference from adjacent channel(s), interference from other devices and/or systems using frequencies near the frequency band of interest, or undesirable harmonics of desired signals that fall within the frequency of interest of another receiver). For example, in a cable television system, the third harmonic of many UHF signals in the 300-500 MHz range can adversely affect the ability of a receiver to accurately recover MOCA data within the 1 MHz-1.5 MHz range.

This and other disadvantages of conventional and traditional approaches with be apparent to one skilled in the art when presented the disclosure of the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of a multi-band receiver 75 in accordance with an embodiment of the present invention.

FIG. 2 is an example frequency spectrum in accordance with an embodiment of the present invention.

FIG. 3 is a schematic block diagram of a receiver 100 in accordance with an embodiment of the present invention.

FIG. 4 is a schematic block diagram of a harmonic cancellation module 125 in accordance with an embodiment of the present invention.

FIG. 5 is a schematic block diagram of signal modeling module 200 in accordance with an embodiment of the present invention.

FIG. 6 is a schematic block diagram of a receiver 127 in accordance with an embodiment of the present invention.

FIG. 7 is a schematic block diagram of a receiver 127′ in accordance with an embodiment of the present invention.

FIG. 8 is a flowchart representation of a method in accordance with an embodiment of the present invention.

FIG. 9 is a flowchart representation of a method in accordance with an embodiment of the present invention.

### DETAILED DESCRIPTION OF THE INVENTION

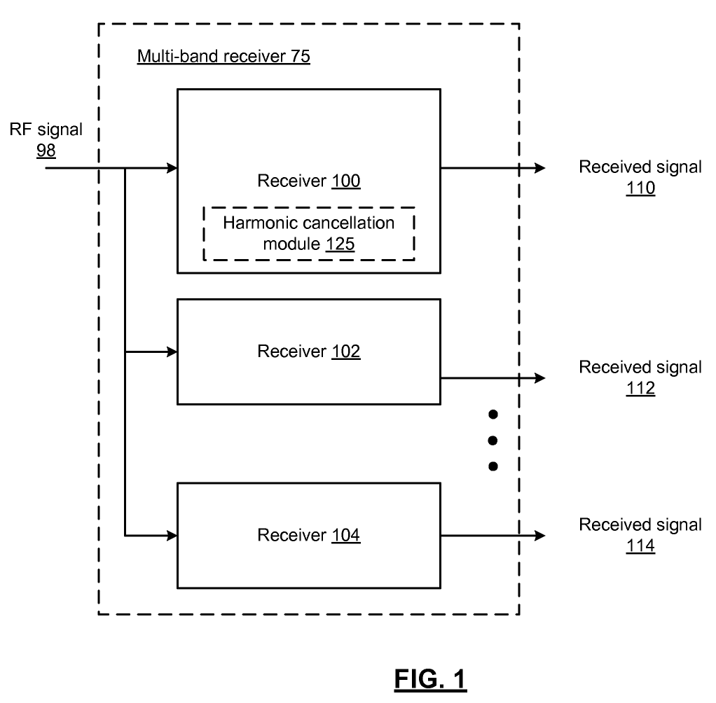

FIG. 1 is a schematic block diagram of a multi-band receiver 75 in accordance with an embodiment of the present invention. In particular a multi-band receiver 75 is shown that includes a plurality of separate receivers/receiver sections 100, 102 and 104 for converting components of RF signal 98 to corresponding received signals 110, 122 and 114. In an embodiment of the present invention, multi-band receiver 75 receives an RF signal 98 from a cable, satellite or other broadcast or multicast television network. The RF signal 98 can contain several desirable signal components, with each signal component falling in its own range of frequencies.

Receivers 100, 102, 104, etc., are configured to receive signals only within one of these particular ranges. For instance, desired components of RF signal 98 can include analog over-the-air or cable TV signals, digital over-the-air signals, digital cable signals, broadcast satellite signals, digital broadband data signals, multimedia over co-axial (MOCA) signals and/or other signaling. While described above in conjunction with the reception of multi-band signals used in conjunction with television network, the principles of the present invention can likewise be applied to other multi-band RF signals 98 and other networks as will be understood by one skilled in the art when presented the disclosure contained herein.

As discussed above, receivers 100, 102, 104, etc., are configured to receive signals only within a particular range that corresponds to particular signal components of the RF signal 98. The operation of multi-band receiver 75 can be described in conjunction with the example frequency spectrum presented in FIG. 2. In particular, consider the case where the spectrum of RF signal 98 is shown in FIG. 2. In this example, RF signal 98 includes downstream (DS) and upstream (US) data signals having reserved spectra below 45 MHz. Analog television signals are present in a very high frequency (VHF) band. Digital UHF television signals are carried in the frequency range 300-500 MHz. In addition, RF signal 98 includes MOCA signals in the 1 GHz-1.5 GHz range. It should be noted that the frequency spectrum of FIG. 2 is not drawn to scale.

In this example, receiver 100 receives the MOCA component of the RF signal 98 in the range of 1.0-1.5 GHz, and generates a received signal 110 that includes MOCA data. Receiver 102 can be a UHF receiver that receives the UHF component of RF signal 98 in the 300-55 MHz range and generates a received signal 112 that includes one or more digital television signals. Receiver 104 can be a VHF receiver that generates a received signal 114 that includes one or more analog television signals. A transceiver (not specifically shown) can also be included for transceiving the US and DS data between the subscriber unit that includes multi-band receiver 75 and the network.

As shown, receiver 100 includes a harmonic cancellation module 125 that attenuates a harmonic of one or more of the desired signal component that falls within the range of frequencies processed by receiver 100. In this example, the signals in the UHF range have third harmonics at frequencies between 900 MHz and 1.5 GHz, a range that includes the input range of the receiver 100. Harmonic cancellation module 125 operates to attenuate these third harmonics while passing the MOCA component of the RF signal 98, to improve the performance of receiver 100 in the presence of this source of potential interference.

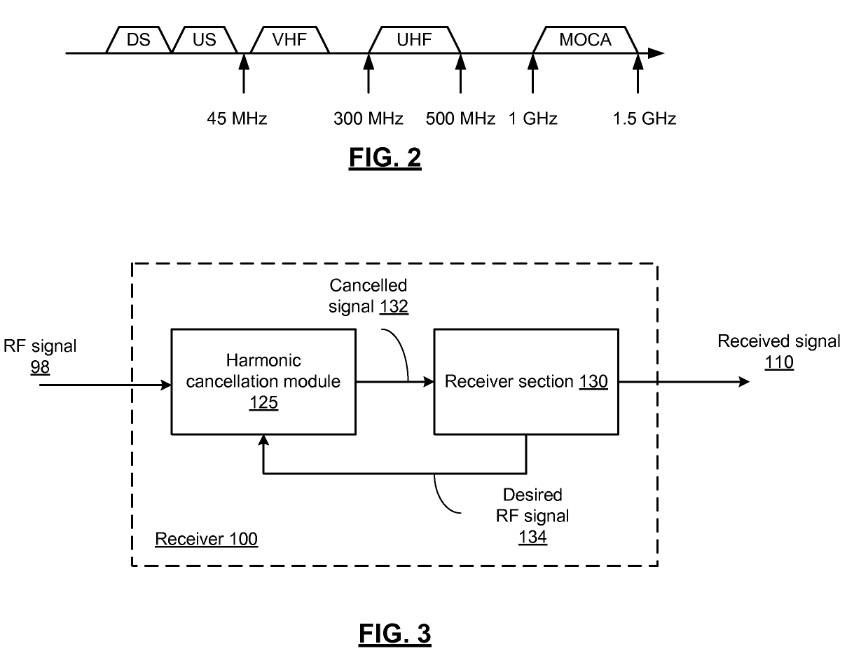

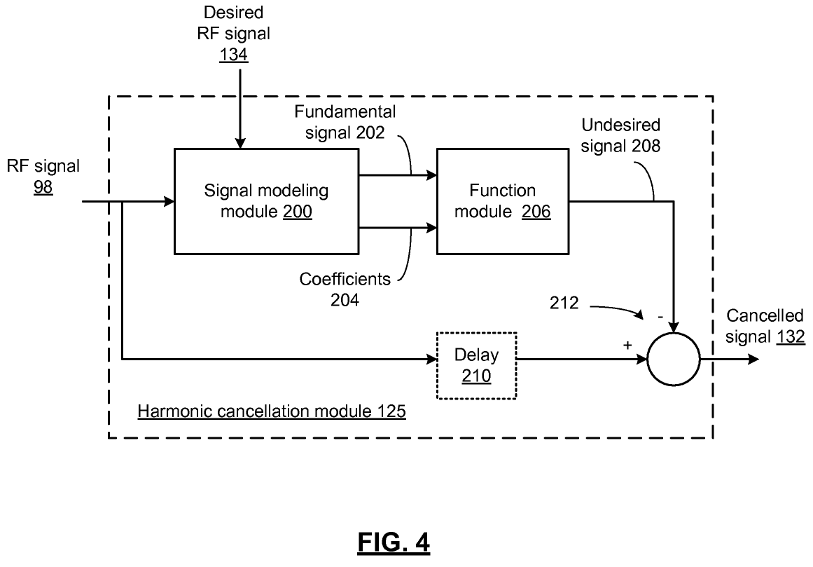

Further function and features relating to the operation of harmonic cancellation module 125 including optional implementations are described in conjunction with FIGS. 3-9 that follow.

FIG. 3 is a schematic block diagram of a receiver 100 in accordance with an embodiment of the present invention. In particular, receiver 100 includes a receiver section 130 that generates the received signal 110 from a cancelled signal 132 produced by harmonic processing module 125. In addition, receiver section 130 feeds back desired RF signal 134 that is used by harmonic cancellation module 125 to generate the cancelled signal 132. In particular, harmonic cancellation module uses the desired RF signal 134 in attenuating the undesired harmonics from the cancelled signal 132.

In an embodiment of the present invention, the harmonic cancellation module 125 includes at least one shared or dedicated processing device. Such a processing device, may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices that are either on-chip or off-chip such as memory. Such a memory device may be a read-only memory, random access memory, volatile memory, non-volatile memory, static memory, dynamic memory, flash memory, and/or any device that stores digital information. Note that when the harmonic cancellation module 125 implements one or more of its functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

FIG. 4 is a schematic block diagram of a harmonic cancellation module 125 in accordance with an embodiment of the present invention. Signal modeling module 200 operates based on the RF signal 98 and the desired RF signal 134 to adaptively model the signal component that is generating the harmonics to be cancelled. In particular, signal modeling module generates a fundamental signal 202 at a fundamental frequency of the signal component that is generating the harmonics to be cancelled. Signal modeling module 200 also generates a plurality of coefficients 204 that can be used to generate the higher order harmonics of this signal component.

Function module 206 generates an undesired signal 208 based on the based on the fundamental signal 202 and the plurality of coefficients 204. In particular, function module 206 replicates higher order harmonics to be cancelled so that these higher-order harmonics can be cancelled from the RF signal 98 by a cancellation module (represented by adder 212) to form cancelled signal 132. Delay 210 is optionally included to correspond to the delay introduced by the signal modeling module 200 and function module 206 in the formulation of undesired signal 208.

The operation function module 206 and signal modeling module 200 can be described in conjunction with the example presented in conjunction with FIGS. 2 and 3. In this example, signal modeling module 200 isolates the fundamental of one or more UHF signals whose third harmonics could potentially cause interference with the receiver 100. Signal modeling module 200 further generates coefficients 204 that can be used by function module 206 to generate an undesired signal 208 that includes these unwanted third harmonics. In an embodiment of the present invention, the function module 206 generates undesired signal as a polynomial function of the fundamental signal 202 wherein the coefficients 204 are the coefficients of this polynomial function. In other words, consider the fundamental signal as being x(t) or simply x, and the coefficients 204 to be c₁, c₂, c₃, . . . cₙ. The undesired signal 208 can be generated by function module 206 based on a function,

ƒ(x)=c₁x+c₂x²+c₃x³+ . . . cₙxⁿ

As the UHF signals vary in terms of either the strengths or relative strength of fundamental and harmonics, the signal modeling module 200 tracks these changes and updates the model so that function module 206 generates a representation as undesired signal 208. While the undesirable harmonics could, in theory, be completely cancelled, limited precision in the model, small phase errors and other sources of error in signal modeling module 200 limit the depth of the cancellation. However, cancelled signal 132 can have a resulting spectrum where, in the example discussed above, the third harmonics of the UHF signal components are attenuated while the MOCA signal components are passed.

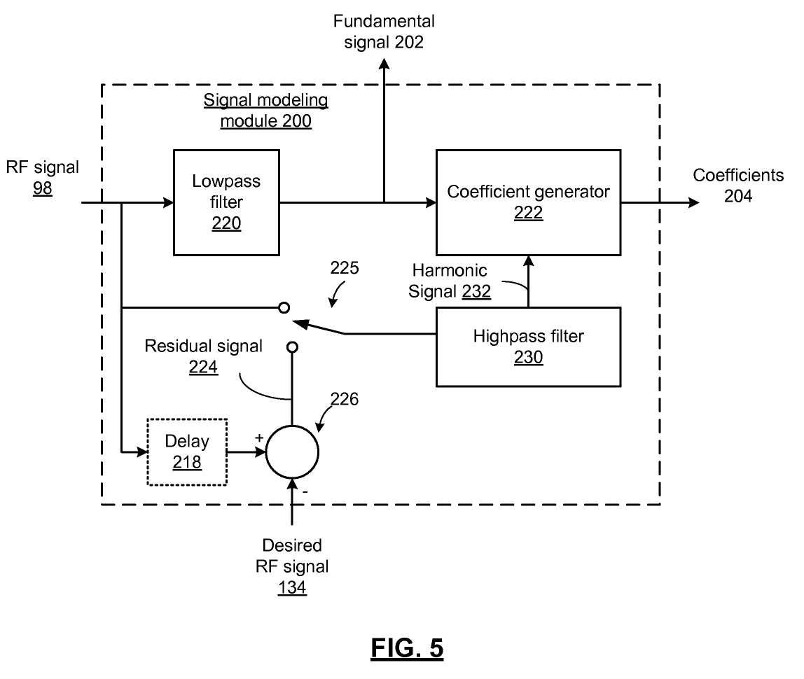

Further function and features relating to the operation of signal modeling module 200 including optional implementations are described in conjunction with FIG. 5 that follows.

FIG. 5 is a schematic block diagram of signal modeling module 200 in accordance with an embodiment of the present invention. In particular, signal modeling module 200 includes a low pass filter 220 with sufficient cutoff to generate the fundamental signal 202 based on the RF signal 98. In the example described in conjunction with FIGS. 2-4 above, the lowpass filter has a cutoff frequency above 500 MHz, but below 1 GHz to isolate the fundamental of the UHF signals from the MOCA signals. Lowpass filter 220 can be implemented with a digital filter such as a finite impulse response (FIR) or infinite impulse response (IIR) filter, or an analog filter. Lowpass filter 220 can optionally include a high-pass section, for instance, to filter VHF and lower frequency data signals from the fundamental signal 202.

A residual signal 224 is formed by subtracting the desired RF signal 134 from the RF signal 98 through a cancellation module shown here as implemented by adder 226. Optional delay 218 is include to synchronize the timing of desired RF signal 134 with RF signal 98. In a steady state condition, 225 is coupled to residual signal 224. The high-pass filter 230 generates a harmonic signal 232 by filtering out the fundamental component and lower frequencies from the residual signal 224. When the signal modeling module is being initialized, switch 225 is switched to couple the RF signal 98 directly to the highpass filter 230. The coefficient generator 222 generates the coefficients 204 based on the harmonic signal 232 and the fundamental signal 202.

In terms of the example discussed in conjunction with FIGS. 2-4 and above, the MOCA signal is cancelled from the residual signal 224 by adder 226. In steady state, the highpass filter filters out the fundamental component of the UHF signals leaving only the high-order harmonics as harmonic signal 232. Coefficient generator 222, in turn generates coefficients 204 based on an analysis of the fundamental and harmonics of the UHF signals. In an embodiment of the present invention coefficient generator 222 implements a least squares fit or other polynomial fitting technique to determine the values of coefficients 204. During initialization, the harmonic signal 232 may include components of the MOCA signal, however, closing the loop by switching to residual signal 224 refines the modeling of the UHF signal while adapting to the relative strengths of the UHF signal's fundamental and harmonic components.

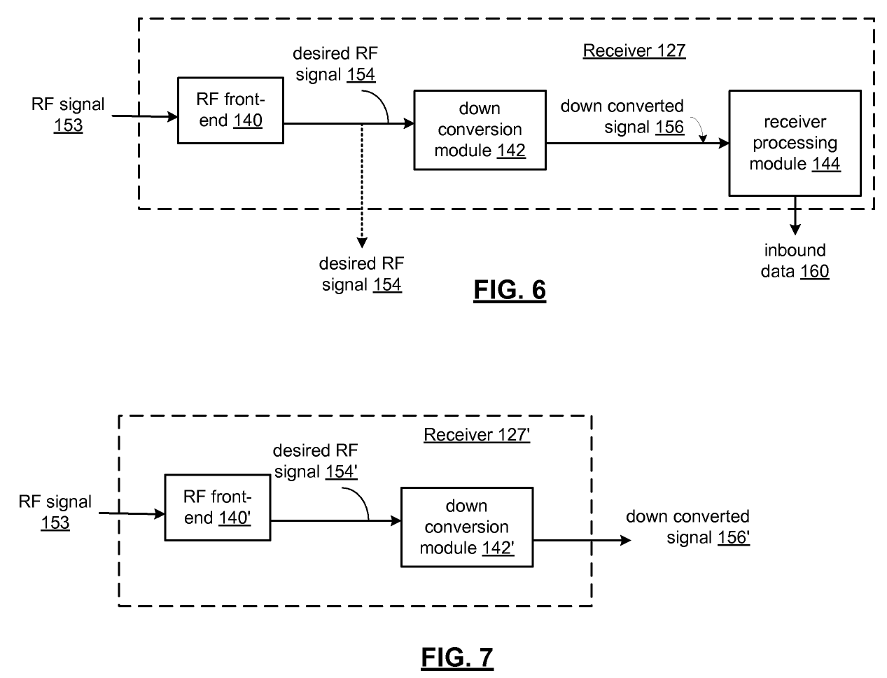

FIG. 6 is a schematic block diagram of an RF receiver 127 in an embodiment of the present invention. In particular, the RF receiver 127 can be used in receiver section 130 or receivers 102, 104, etc. Receiver 127 includes a RF front end 140, a down conversion module 142, and a receiver processing module 144.

In operation, the receiver 127 operates in the same frequency band or otherwise over the same range of frequencies that are received through its RF front-end. The RF front-end 140 can include a low noise amplifier and optional filtration to generate a desired RF signal 154 from RF signal 153, such as either RF signal 98 or cancelled signal 132. The down conversion module 142 includes a mixing section, an optional analog to digital conversion (ADC) module, and may also include a filtering and/or gain module. The mixing section converts the desired RF signal 154 into a down converted signal 156 that is based on a receiver local oscillation, such as an analog baseband or low IF signal. The optional ADC module converts the analog baseband or low IF signal into a digital baseband or low IF signal. The filtering and/or gain module high pass and/or low pass filters the digital baseband or low IF signal to produce a baseband or low IF signal 156. Note that the ordering of the ADC module and filtering and/or gain module may be switched, such that the filtering and/or gain module is an analog module. When the receiver 127 implements receiver section 130, desired RF signal 154 can be used as desired RF signal 134. In the alternative inbound data 160 can be remodulated by a modulation module (not shown) to generate desired RF signal 134.

The receiver processing module 144 processes the baseband or low IF signal 156 in accordance with a particular signal format to produce inbound data 160. The processing performed by the receiver processing module 144 includes, but is not limited to, digital intermediate frequency to baseband conversion, demodulation, demapping, depuncturing, decoding, and/or descrambling. Note that the receiver processing modules 144 may be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the receiver processing module 144 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

FIG. 7 is a schematic block diagram of a receiver 127′ in accordance with an embodiment of the present invention. In particular, receiver 127′ can be used in circumstances where one or more of the receivers 102, 104, etc. operate based on analog signals, for instance, VHF television signals. The RF front-end 140′ includes a low noise amplifier and optional filtration to generate a desired RF signal 154′ from RF signal 153, such as RF signal 98. The down conversion module 142′ includes a mixing section, and may also include a filtering and/or gain module. The mixing section converts the desired RF signal 154′ into a down converted signal 156′ such as an analog baseband signal.

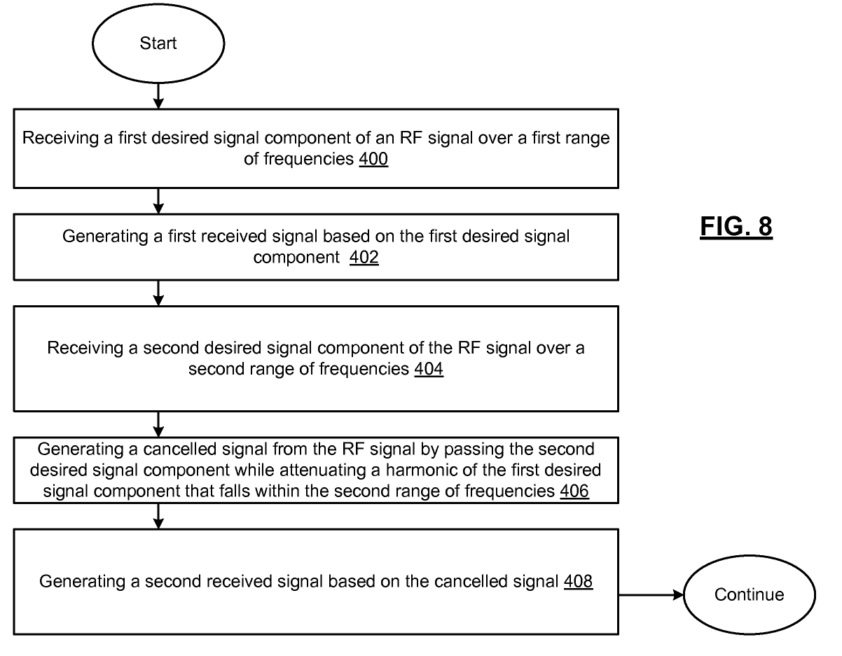

FIG. 8 is a flowchart representation of a method in accordance with an embodiment of the present invention. In particular a method is presented for use with one or more features or functions presented in conjunction with FIGS. 1-7. In step 400, a first desired signal component of an RF signal is received over a first range of frequencies. In step 402, a first received signal is generated based on the first desired signal component. In step 404, a second desired signal component of the RF signal is received over a second range of frequencies. In step 406, a cancelled signal is generated from the RF signal by passing the second desired signal component while attenuating a harmonic of the first desired signal component that falls within the second range of frequencies. In step 408, a second received signal is generated based on the cancelled signal.

In an embodiment of the present invention, the first desired signal component includes an ultra-high frequency (UHF) television signal and the second desired signal component includes a multimedia data signal.

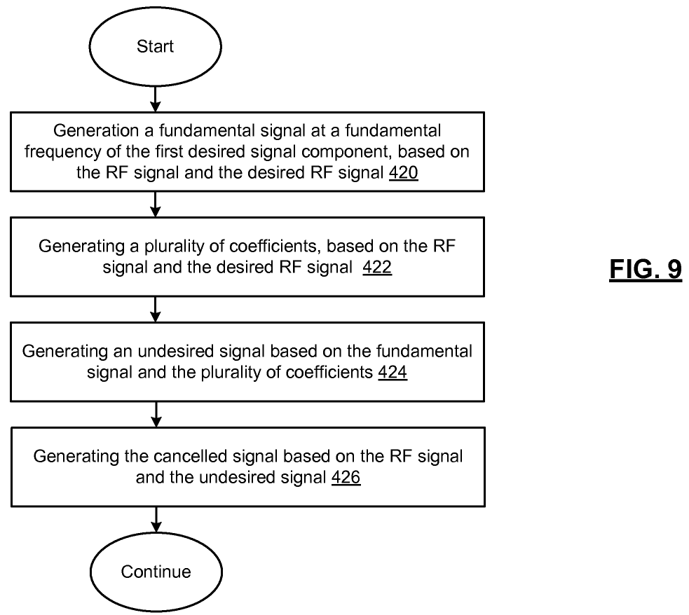

FIG. 9 is a flowchart representation of a method in accordance with an embodiment of the present invention. In particular, a method is presented for use with one or more features or functions presented in conjunction with FIG. 8 and in particular in the conjunction with step 406. In step 420, a fundamental signal is generated at a fundamental frequency of the first desired signal component, based on the RF signal and the desired RF signal. In step 422, a plurality of coefficients are generated, based on the RF signal and the desired RF signal. In step 424, an undesired signal is generated based on the fundamental signal and the plurality of coefficients. In step 426, the cancelled signal is generated based on the RF signal and the undesired signal.

In an embodiment of the present invention, the undesired signal is generated based on a polynomial function of the fundamental signal and wherein the plurality of coefficients include coefficients of the polynomial function. The fundamental signal can be generated by lowpass filtering the RF signal. Generating the plurality of coefficients can include high-pass filtering a residual signal in a first state to generate a harmonic signal and/or high-pass filtering the RF signal in a second state to generate the harmonic signal. Generating the plurality of coefficients can further include generating the residual signal based on the desired RF signal. The plurality of coefficients can be generated based on the harmonic signal and the fundamental signal.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

While the transistors discussed above may be field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A multi-band receiver comprising:
a first receiver coupled to receive a first desired signal component of an RF signal over a first range of frequencies and generate a first received signal; and
a second receiver, coupled to receive a second desired signal component of the RF signal over a second range of frequencies and generate a second received signal, wherein the second receiver includes a harmonic cancellation module that attenuates a harmonic of the first desired signal component that falls within the second range of frequencies.

2. The multi-band receiver of claim 1, wherein the first desired signal component includes an ultra-high frequency (UHF) television signal and the second desired signal component includes a multimedia data signal.

3. The multi-band receiver of claim 1, wherein second receiver further includes:
a receiver section, coupled to the harmonic cancellation module, that generates the second received signal and a desired RF signal based on a cancelled signal;
wherein the harmonic cancellation module generates the cancelled signal based on the RF signal and the desired RF signal.

4. The multi-band receiver of claim 3, wherein harmonic cancellation module includes:
a signal modeling module that generates a fundamental signal at a fundamental frequency of the first desired signal component and that generates a plurality of coefficients, based on the RF signal and the desired RF signal;
a function module, coupled to the signal modeling module, that generates an undesired signal based on the fundamental signal and the plurality of coefficients; and
a first cancellation module, coupled to the function module, that generates the cancelled signal based on the RF signal and the undesired signal.

5. The multi-band receiver of claim 4 wherein the function module generates the undesired signal based on a polynomial function of the fundamental signal and wherein the plurality of coefficients include coefficients of the polynomial function.

6. The multi-band receiver of claim 4 wherein the signal modeling module includes a low pass filter that generates the fundamental signal based on the RF signal.

7. The multi-band receiver of claim 4 wherein signal modeling module includes a high-pass filter that generates a harmonic signal based on a residual signal in a first state.

8. The multi-band receiver of claim 7 wherein the high-pass filter generates the harmonic signal based on the RF signal in a second state.

9. The multi-band receiver of claim 7 wherein signal modeling module includes a second cancellation module that generates a residual signal based on the desired RF signal and the RF signal.

10. The multi-band receiver of claim 7 wherein signal modeling module includes a coefficient generator that generates the plurality of coefficients based on the harmonic signal and the fundamental signal.

11. A method comprising:
receiving a first desired signal component of an RF signal over a first range of frequencies;
generating a first received signal based on the first desired signal component;
receiving a second desired signal component of the RF signal over a second range of frequencies;
generating a cancelled signal from the RF signal by passing the second desired signal component while attenuating a harmonic of the first desired signal component that falls within the second range of frequencies; and
generating a second received signal based on the cancelled signal.

12. The method of claim 11, wherein the first desired signal component includes an ultra-high frequency (UHF) television signal and the second desired signal component includes a multimedia data signal.

13. The method of claim 11, wherein generating the cancelled signal includes:
generating a fundamental signal at a fundamental frequency of the first desired signal component, based on the RF signal and the desired RF signal;
generating a plurality of coefficients, based on the RF signal and the desired RF signal;
generating an undesired signal based on the fundamental signal and the plurality of coefficients; and
generating the cancelled signal based on the RF signal and the undesired signal.

14. The method of claim 13 wherein the undesired signal is generated based on a polynomial function of the fundamental signal and wherein the plurality of coefficients include coefficients of the polynomial function.

15. The method of claim 13 wherein the fundamental signal is generated by lowpass filtering the RF signal.

16. The method of claim 13 wherein generating the plurality of coefficients includes high-pass filtering a residual signal in a first state to generate a harmonic signal.

17. The method of claim 16 wherein generating the plurality of coefficients includes high-pass filtering the RF signal in a second state to generate the harmonic signal.

18. The method of claim 16 wherein generating the plurality of coefficients includes generating the residual signal based on the desired RF signal and the RF signal.

19. The method of claim 16 wherein the plurality of coefficients are generated based on the harmonic signal and the fundamental signal.
